(19) United States
(12) Patent Application Publication
(10) Pub. No.: US 2007/0240121 A1
(43) Pub. Date: Oct. 11, 2007

(54) System for evaluating component value

(75) Inventor: John M. Spangler, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/342,702

(22) Filed: Jan. 31, 2006

(51) Int. Cl. G06F 9/44

(52) U.S. Cl. 717/127

(57) ABSTRACT

A method is disclosed for determining a value of a manipulated component. The method includes compiling information indicative of a process configured to manipulate the component. The method also includes determining a quality of the manipulated component as a function of the compiled information and determining a cost of the manipulated component. The method further includes determining the value of the manipulated component as a function of the quality and cost of the manipulated component.

### TECHNICAL FIELD

The present disclosure relates to a system for evaluating value and, more particularly, to a method and apparatus for evaluating component value.

### BACKGROUND

Finished products, such as, for example, work machines, typically require a plurality of components to produce. Each of the components are usually manipulated within processes, such as, for example, fabrication processes, manufacturing processes, or coating processes. The components are usually further manipulated within an assembly process to produce the finished product.

A producer of a finished product, such as, for example, a company or other entity, often out-sources the manipulation of one or more components to suppliers. Typically, a producer selects suppliers from which to procure manipulated components based on various criteria, such as, for example, knowledge about or experience with the supplier, the supplier's reputation within an industry, and/or past dealings with the supplier. However, such criteria often requires significant producer investment to discover and usually includes significant risk. For example, a producer takes a risk when selecting a new supplier based on reputation and/or incurs a significant investment of time and capital when establishing experience with a supplier over several years.

Additionally, different suppliers manipulate particular types of components to different degrees of quality and the producer may incur different costs for a particular component as a function of a selected supplier and the associated degree of quality. Often, a producer may not desire all out-sourced components to be manipulated at a high quality but may only procure components from high quality suppliers because of a lack of confidence in other suppliers. Similarly, a producer may desire some out-sourced components to be manipulated at a high degree of quality but may procure low quality components because selected suppliers are inaccurately determined to be high quality suppliers for such components.

U.S. Pat. No. 6,922,684 (“the '684 patent”) issued to Aldridge et al. discloses a support system for improving management of quality and cost of a product. The system of the '684 patent includes a data store for collecting detailed data pertaining to a component and an analytics subsystem for compiling subsets of the detailed data. The analytics subsystem includes a first analysis tool configured to perform cost or quality analysis on the subsets and a second analysis tool configured to analyze the detailed data to identify correlations therein. The system of the '684 patent also includes a management and operation subsystem configured to facilitate interaction with a user for presenting the results of the first and second analysis tools. The system of the '684 patent further includes a warning notification subsystem configured to deliver warnings to the user when one or more cost or quality factors, determined by the first analysis tool, meet a threshold. The user may then configure the second analysis tool to determine any correlation between the warning and other detailed data.

Although the system of the '684 patent may analyze cost or quality, it may perform the analysis after the components are manipulated. Also, the system of the '684 patent may not functionally relate cost and quality of a manipulated component to evaluate component value. Additionally, the system of the '684 patent may identify suppliers manipulating components outside predetermined cost or quality thresholds, but may not determine operability of a process to manipulate components to a desired specifications or requirements.

The present disclosure is directed to overcoming one or more of the shortcomings set forth above.

### SUMMARY OF THE INVENTION

In one aspect, the present disclosure is directed to a method for determining a value of a manipulated component. The method includes compiling information indicative of a process configured to manipulate the component. The method also includes determining a quality of the manipulated component as a function of the compiled information and determining a cost of the manipulated component. The method further includes determining the value of the manipulated component as a function of the quality and cost of the manipulated component.

In another aspect, the present disclosure is directed to a system for determining a value of a component. The system includes a computer configured to receive at least one first input from a user and a user interface configured to display at least one output. The system also includes a program configured to receive at least one second input from the computer. The program is also configured to access a database populated with data indicative of a process configured to manipulate the component. The program is further configured to determine a quality of the component as a function of the data indicative of the process and determine the value of the component as a function of the determined quality.

In yet another aspect, the present disclosure is directed to a method for evaluating a plurality of processes each configured to manipulate at least one component. The method includes determining for each of the plurality of processes a cost of manipulating the at least one component, a quality of manipulating the at least one component as a function of information indicative of the process, and a value of manipulating the at least one component as a function of the cost and the quality of the at least one component. The method also includes comparing each value of the plurality of processes with one another and identifying one of the plurality of processes having the highest value.

### BRIEF DESCRIPTION OF THE DRAWINGS

FIG. 1 is a flow chart of an exemplary method for evaluating component value in accordance with the present disclosure; and

FIG. 2 is a schematic illustration of an exemplary system for performing the method of FIG. 1.

### DETAILED DESCRIPTION

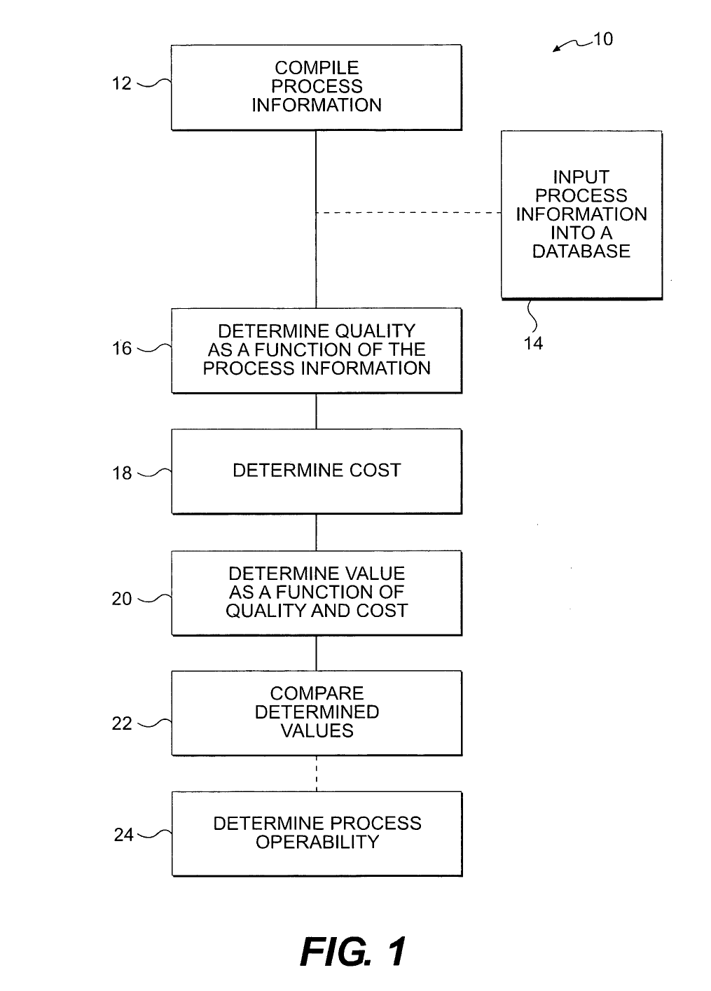

FIG. 1 illustrates an exemplary method 10 for evaluating component value. Specifically, method 10 may include compiling process information, step 12, and may also include inputting the process information into a database, step 14. Method 10 may also include determining quality as a function of the process information, step 16, and determining a cost, step 18. Method 10 may also include determining value as a function of quality and cost, step 20, and evaluating the determined values, step 22. Method 10 may further include determining process operability, step 24. It is contemplated that method 10 may be performed and/or operated as a continuous method, as a non-continuous method, as a batch method, and/or as any other method known in the art. It is also contemplated that method 10 may be performed for any quantity of processes and/or components to determine any quantity of values.

Step 12 may include compiling process information and may include obtaining information, e.g., data, regarding one or more processes and arranging such information in any suitable format. For example, step 12 may include receiving responses, e.g., answers, to one or more requests for information submitted to one or more potential suppliers and arranging the data in a spreadsheet. The responses may include any type of data, such as, for example, text, numbers, selections of multiple choice questions, and/or any other type of response. The requests for information may be configured to solicit responses indicative of any type of process information, such as, for example, a type of process, e.g., a continuous process, a disconnected process, a single line process, or a multi-line process, a type or size of equipment within a process, e.g., the size of an operating envelope for manipulating components or a brand of equipment, cycle times for manipulating components within a process, lead times desired or required for manipulating components within a process, and/or any other information regarding a process known in the art. Additionally, step 12 may include performing an audit or investigation of a process, e.g., a process operated by a potential supplier, to obtain and compile information. Furthermore, step 12 may include identifying information regarding a conceptual process during the design of the conceptual process.

It is contemplated that a process may be any operation configured to affect any type of manipulation, such as, for example, tooling, coating, geometry shaping, heat treating, packaging, transporting, arranging, refining, assembling, and/or any other type of manipulation. It is also contemplated that a process may include an existing or conceptual process and may include any type of process, such as, for example, a refining process, a fabrication process, a manufacturing process, a coating process, an assembly process, a packaging process, a warehousing process, and/or a combination of one or more such processes. It is further contemplated that the process information may be compiled and/or arranged manually, e.g., data entry, automatically, e.g., an algorithm and/or executable program, electronically, e.g., via a microprocessor, physically, e.g., via writing, and/or any other suitable method.

Step 14 may include inputting the process information into a database. Specifically, the compiled process information may be temporarily or permanently stored within an electronic database either within a fixed or removable memory. The compiled information may be input into any known database, e.g., a multi-dimensional spreadsheet, via any known method, e.g., numerical or text entry via a user input device, e.g., a keyboard. It is contemplated that the database may be utilized to store any quantity of data indicative of process information for any quantity of processes. It is also contemplated that the database may enable comparing existing processes and/or suppliers with conceptual processes or new suppliers. It is further contemplated that step 14 may or may not be performed within method 10.

Step 16 may include determining quality as a function of the process information and thus as a function of the quality of the process. Specifically, process information for a particular process may be compared to process information for other processes to arrange the one or more processes within a hierarchy. As such, the relative quality, e.g., the likelihood or probability that a process may manipulate a component to desired specifications and requirements, of the processes may be ranked. For example, the compiled process information may include data identifying a first process as a single continuous line process and may include data identifying a second process as a multi-line disconnected process. The respective processes may be compared with one another, and the second process might be ranked above the first process because a multi-line process may be more likely to manipulate a component to the desired specifications than a single line process, e.g., a multi-line process may be more likely to manipulate one or more components at or above the desired specifications.

Additionally, quality may be determined as a function of the type, e.g., different size, weight, material, geometry, desired manipulation, manipulation time, e.g., cycle or take time, and/or lead time, of component to be manipulated. Specifically, the compiled process information may be evaluated with respect to the type of component to be manipulated. Additionally, a particular process may have different qualities dependent upon different types of components. For example, the process information for a particular process may be evaluated for two or more different types, e.g., different size, components. As such, a process having a small manipulation envelope may have a higher capability of manipulating small components at or above desired specifications and thus may have a high quality for the relatively smaller size component but may have a low quality for relatively larger size components. It is contemplated that different types of processes may be predetermined to be more desirous than others, e.g., a multi-line process may be determined to be more desirous than a single line process. It is also contemplated that predetermined quality parameters may be determined as a function of one or more different types of processes, e.g., known types of processes and/or known types of process equipment may be prearranged within a hierarchy and the compiled process information may be compared with the prearranged hierarchy. Accordingly, the quality of the process may be determined to be the quality of the predetermined quality parameter that is associated with a type of process and/or process equipment that substantially matches the compiled process information. It is further contemplated that a quality may be determined via any suitable look-up table, algorithm, multi-dimensional map, and/or any other comparison method and that such functions may be populated based on any suitable criteria, such as, test or trial results, experimentation, historical records, and/or may or may not be dependent upon the type of component to be manipulated.

Step 18 may include determining cost. Specifically, the compiled process information may include information regarding a price for procuring manipulated components from particular suppliers. For example, a supplier may provide a price for a manipulated component in response to one or more requests for information. It is contemplated that the cost may be indicative of a price per component for a given quantity of components. It is also contemplated that the cost may be determined by evaluating a process as a function of the compiled process information to predict a cost that might be incurred to manipulate the component. For example, the compiled information may be evaluated to predict a cost of manipulating, e.g., the cost of utilities and/or labor to operate a process to manipulate a component, for either a supplier's proposed process and/or a conceptual process. It is further contemplated that the determined cost may or may not include costs associated with transporting manipulated parts from one supplier to another and/or from a supplier to a producer.

Step 20 may include determining value as a function of quality and cost. Specifically, a value of a component may be determined by dividing a numerical representation of quality by a numerical representation of cost wherein a higher numerical value may be indicative of a higher component value. For example, one or more processes may be ranked as a function of quality and numerically represented by integers, e.g., a first process may be ranked as a quality of 3 and a second process may be ranked as a quality of 1, wherein 3 represents a higher quality than 1. Accordingly, if the cost for a component of the first and second processes is $0.50 the values of the first and second components may be represented as 6 and 2, respectively. It is contemplated that the numerical representations of quality and cost may each be respectively based on a common scale, such as, for example, relative rankings within the same hierarchy or prices based on a common currency. Accordingly, one or more determined values may be related with one another within common units, e.g., rank per dollars. It is also contemplated that value may be determined via any suitable mathematical relationship, such as, for example, multiplying, raising to powers, an equation, and/or any other suitable functional relationship.

Step 22 may include evaluating determined values. Specifically, one or more determined component values may be functionally related with one another and arranged within a hierarchy. Accordingly, the processes and respective suppliers associated with a value may also be evaluated with respect to other processes or suppliers. As such, the process and/or supplier associated with the highest ranked value may be identified as a function of the compiled process information. It is contemplated that the producer may select the supplier associated with the highest ranked value and out-source the manipulation of the component to the selected supplier.

Step 24 may include determining process operability. Specifically, the one or more processes may be evaluated as a function of the determined component values to determine the operability of the process to manipulate the component to desired specifications and/or requirements. For example, a process associated with a determined low ranked value may be indicative of a lower quality process as compared to a process associated with a determined high ranked value. As such, the operability of a process to manipulate a component may be determined as a function of the associated value hierarchy, e.g., the operability of a process to manipulate a component at or above desired specifications may be more likely if associated with a high ranked value rather than if associated with a low ranked value. It is contemplated that a producer may identify processes associated with a low ranked value as a low value process and thus may select such a process for manipulating low value components. It is also contemplated that by evaluating component value, a producer may more accurately match processes, and thus suppliers, with component value, e.g., select high quality supplier to manipulate high quality components and select low quality supplier to manipulate low quality components. It is further contemplated that step 24 may or may not be performed within method 10.

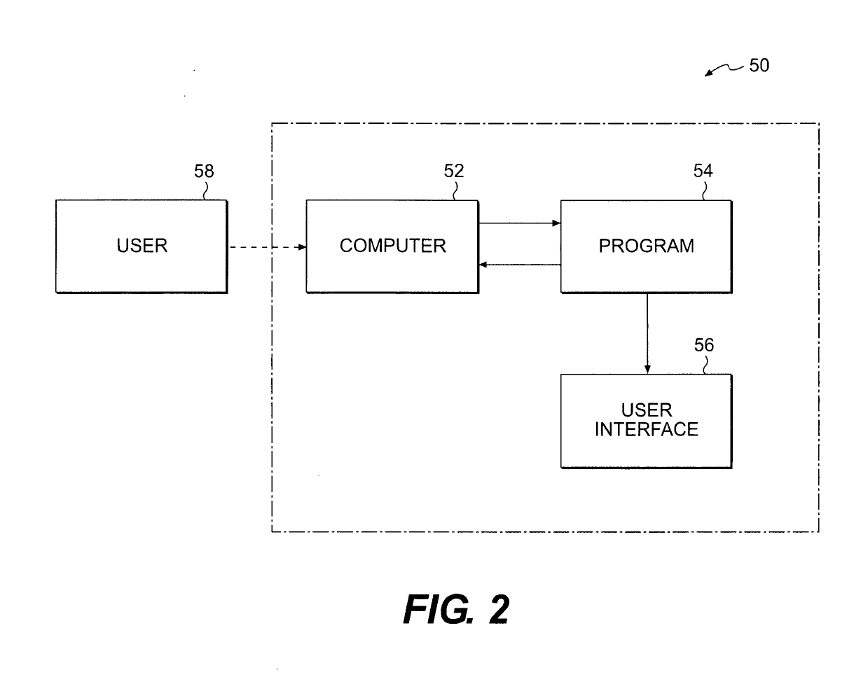

FIG. 2 illustrates an exemplary system 50 for performing method 10. System 50 may include a computer 52, a program 54, and a user interface 56. System 50 may be configured to accept inputs from a user 58 via computer 52 to determine and evaluate one or more component values. System 50 may be further configured to display data and/or graphics in user interface 56 representative of the determined component values. It is contemplated that system 50 may include additional components such as, for example, a communications interface (not shown), a memory (not shown), databases (not shown), and/or other components known in the art.

Computer 52 may include a general purpose computer configured to operate executable computer code. Computer 52 may include one or more input devices, such as, for example, a keyboard (not shown) or a mouse (not shown) to introduce user inputs into computer 52. User 58 may input one or more inputs, e.g., data, indicative of the compiled process information into system 50 via computer 52 and/or a command to execute program 54. Computer 52 may also include one or more data manipulation devices, such as, for example, databases (not shown) or software programs (not shown) to transfer and/or alter user inputs. Computer 52 may also include one or more communication devices, such as, for example, a modem (not shown) or a network link (not shown) to communicate inputs and/or outputs with program 54. Computer 52 may also communicate inputs, e.g., data, indicative of the compiled process information and/or a command to execute program 54, to program 54. It is contemplated that computer 52 may further include additional and/or different components, such as, for example, a memory (not shown), a communications hub (not shown), a data storage (not shown), a printer (not shown), an audio-video device (not shown), removable data storage devices (not shown), or other components known in the art. It is also contemplated that computer 52 may communicate with program 54 via, for example, a local area network (“LAN”), a hardwired connection, and/or the Internet.

Program 54 may include a computer executable code routine configured to perform one or more sub-routines and/or algorithms to determine and evaluate component values and determine process operability within system 50. Specifically, program 54 may be configured to perform method 10. Program 54 may receive inputs from computer 52 and perform one or more algorithms to manipulate the received data and communicate one or more outputs, e.g., determined values, quality or value hierarchies, and/or other outputs, to user interface 56. It is contemplated that program 54 may be stored within the memory (not shown) of computer 52 and/or stored on a remote server (not shown) accessible by computer 52. It is also contemplated that program 54 may include additional sub-routines and/or algorithms to perform various other operations with respect to mathematically representing data, generating or importing additional data into program 54, and/or performing other computer executable operations.

User interface 56 may be configured to interact with program 54 to visually display and/or represent relationships of data to user 58. Specifically, user interface 56 may be configured to display the outputs communicated from program 54 via one or more relationships to user 58. It is contemplated that user interface 56 may display a plurality of numbers, text, graphics, and/or any other indicia.

### INDUSTRIAL APPLICABILITY

The disclosed system may be applicable to any manipulation of a component and may be configured to functionally relate quality and cost to determine and evaluate component value. The disclosed system may also be applicable to predict a quality of a process and thus evaluate the operability of the process. The operation of method 10 is explained below.

A producer of a finished product may manipulate a plurality of components necessary and/or desired for the finished product in-house. The producer may desire to out-source the manipulation and/or construct new in-house processes to manipulate a subset of the plurality of components. Accordingly, the producer may compile information indicative of one or more processes (step 12), e.g., may compile information received from potential suppliers via responses to requests for information and/or indicative of conceptual processes proposed to be constructed. The producer may determine a quality (step 16) and a cost (step 18) associated with each process manipulating a component as a function of the compiled information. The producer may determine a plurality of qualities and costs for a given process, each such quality and cost associated with the given process manipulating a particular type or plurality of types of the subset of components. It is contemplated that a quality and cost may not be determined for each process manipulating each type of component of the subset.

The producer may determine a plurality of values as a function of quality and cost (step 20) and may evaluate the determined values (step 22). Specifically, the producer may determine a plurality of qualities and costs each respectively associated with a respective process. Additionally, the producer may functionally relate respective qualities and costs to determine a plurality of component values. Each value may be associated with a process and may be indicative of, for example, the worth or benefit of a component manipulated within that process. The plurality of values for a particular type of component may be compared with one another to establish a hierarchy. Accordingly, the producer may establish one or more hierarchies of component values for each type of component of the subset of components and may select one or more suppliers and/or new in-house processes to manipulate the subset of components as a function of the component value.

Because method 10 may determine a component value as a function of quality and cost, determining a value of a manipulated component may be more accurate than selecting a supplier as a function of experience, knowledge, or reputation. Additionally, processes may be evaluated as a function of the process operability to manipulate a particular component and a producer may more accurately select suppliers from which to procure manipulated parts as a function of the process capability to manipulate the components at or above the desired specifications. Furthermore, method 10 may evaluate processes and thus suppliers as a function of component value and may match high quality suppliers with desired high quality component manipulation and match low quality suppliers with desired low quality component manipulation.

It will be apparent to those skilled in the art that various modifications and variations can be made to the disclosed system for evaluating component value. Other embodiments will be apparent to those skilled in the art from consideration of the specification and practice of the disclosed system. It is intended that the specification and examples be considered as exemplary only, with a true scope being indicated by the following claims and their equivalents

What is claimed is:

1. A method for determining a value of a manipulated component comprising:
compiling information indicative of a process configured to manipulate the component;
determining a quality of the manipulated component as a function of the compiled information;
determining a cost of the manipulated component; and
determining the value of the manipulated component as a function of the quality and cost of the manipulated component.

2. The method of claim 1, wherein determining the quality of the manipulated component includes determining a quality of the process.

3. The method of claim 2, wherein:
the process is a first process configured to be operated by a first supplier; and
determining the quality of the first process includes comparing the first process with a second process configured to be operated by a second supplier.

4. The method of claim 2, wherein:
the process is first process configured as a conceptual process; and
determining the quality of the first process includes comparing the first process with a second process, the second process configured to be either a conceptual process or a process configured to be operated by a supplier.

5. The method of claim 1, wherein:
the manipulated component includes a plurality of manipulated components, the plurality of manipulated components including at least one first component having a first type and at least one second component having a second type, the second type being different than the first type; and
determining a quality of the manipulated component includes determining a first quality of the at least one first component, determining a second quality of the at least one second component.

6. The method of claim 5, wherein the first and second qualities are indicative of the capability of the process to manipulate the at least one first component and manipulate the at least one second component, respectively.

7. The method of claim 1, wherein compiling information includes receiving information from a potential supplier indicative of a process the potential supplier proposes to operate to manipulate the component.

8. The method of claim 1, wherein determining the cost of the manipulated component includes receiving a price quotation for procuring the manipulated component from a potential supplier.

9. A system for determining a value of a component comprising:
a computer configured to receive at least one first input from a user;
a user interface configured to display at least one output; and
a program configured to:
receive at least one second input from the computer,
access a database populated with data indicative of a process configured to manipulate the component,
determine a quality of the component as a function of the data indicative of the process, and
determine the value of the component as a function of the determined quality.

10. The system of claim 9, wherein:
the at least one first input from a user includes a plurality of first inputs;
the plurality of first inputs includes at least one input indicative of the process configured to manipulate the component;
the at least one second input received from the computer includes a plurality of second inputs; and
the program is further configured to populate the database with the data indicative of the plurality of second inputs.

11. The system of claim 9, wherein the program is further configured to:
determine a probability of the process to manipulate the component at or above a desired manipulation requirement; and
determine the quality of the component as a function of the determined probability.

12. The system of claim 9, wherein the program is further configured to determine the quality by:
comparing the data indicative of the process with a predetermined hierarchy of types of processes and associated predetermined process qualities;
substantially matching the data indicative of the process with a type of process within the hierarchy; and
determining the quality of the component as a function of the predetermined process quality associated with the type of process substantially matching the data indicative of the process.

13. The system of claim 9, wherein the at least one output is the determined value of the component.

14. A method for evaluating a plurality of processes each configured to manipulate at least one component comprising:
determining for each of the plurality of processes:
a cost of manipulating the at least one component,
a quality of manipulating the at least one component as a function of information indicative of the process, and
a value of manipulating the at least one component as a function of the cost and the quality of the at least one component;
comparing each value of the plurality of processes with one another; and
identifying one of the plurality of processes having the highest value.

15. The method of claim 14, wherein the information indicative of the process includes at least one of: a type of process, a type of equipment, a size of equipment, a component manipulation time, or a process downtime.

16. The method of claim 14, wherein the at least one component is a plurality of components including at least a first component and a second component, the method further including:
determining for each of the plurality of processes a first value and a second value, respectively associated with the first and second components;
comparing each of the plurality of first values with one another and identifying one of the plurality of processes having the highest first value; and
comparing each of the plurality of second values with one another and identifying one of the plurality of processes having the highest second value.

17. The method of claim 16, wherein the first component and the second component are different at least with respect to at least one of geometry, weight, material, size, desired component manipulation, manipulation cycle time, manipulation take time, or manipulation lead time.

18. The method of claim 14, wherein determining a quality of manipulating the at least one component includes:
comparing the information indicative of the process with predetermined quality parameters;
selecting one of the predetermined quality parameters that substantially matches the information indicative of the process; and
determining the component quality as the selected one of the predetermined quality parameters.

19. The method of claim 18, wherein the predetermined quality parameters are determined as a function of a hierarchy of the plurality of processes.

20. The method of claim 19, wherein the hierarchy is determined by comparing information indicative of a first process and information indicative of the second process, the method further including:
ranking the first process higher than the second process when the first process is determined to be a more desirous process than the second process.

21. The method of claim 14, wherein the at least one component includes a plurality of components, the method further comprising:
determining for each of the plurality of processes a quality of each of the plurality of components as a function of the probability that operating a respective process to manipulate the plurality of components will result in at least a portion of the manipulated plurality of components to be manipulated below specifications.
